(19) United States
(12) Patent Application Publication
(10) Pub. No.: US 2025/0215911 A1
(43) Pub. Date: Jul. 3, 2025

(54) TOOL-FREE CABINET DEVICE

(71) Applicant: Protrend Co., Ltd., Taipei City (TW)

(72) Inventor: SHUN-YI CHEN, Taipei City (TW)

(21) Appl. No.: 18/619,229

(22) Filed: Mar. 28, 2024

(30) Foreign Application Priority Data
Jan. 3, 2024 (TW) 113100198

(51) Int. Cl. F16B 12/22; A47B 47/00; F16B 19/04

(52) U.S. Cl. CPC F16B 12/22; A47B 47/00; F16B 19/04

(57) ABSTRACT

A tool-free cabinet device includes top and bottom plates, two side plates, a rear plate and assembly components. The top and bottom plates respectively include outer and inner surfaces, and configuration groove bodies recessed in the inner surface. The side plate includes upper and lower surfaces, and an insertion groove. The upper surface faces the inner surface of the top plate, the lower surface faces the inner surface of the bottom plate. The left and right sides of the rear plate are inserted in the insertion grooves of the side plates. The assembly component includes female and male fasteners. The female fastener is provided in the configuration groove body. The female fastener includes a first plate element and a keyhole penetrated in the first plate element. The male fasteners are provided on the upper and lower surfaces, and the male fastener is assembled in the keyhole of the female fastener.

### CROSS REFERENCE TO RELATED APPLICATION

All related applications are incorporated by reference. The present application is based on, and claims priority from, Taiwan Application Serial Number 113100198, filed on Jan. 3, 2024, the disclosure of which is hereby incorporated by reference herein in its entirety.

### TECHNICAL FIELD

The present disclosure relates to a cabinet device, and more particularly to a tool-free cabinet device.

### BACKGROUND

A cabinet is a storage device with an opening formed by assembling multiple plates. However, cabinets are inconvenient to be assembled; these plates are usually locked together with combiners and tools. At the same time, they are not easy to disassemble and their usability is reduced.

In addition, due to the need to lock these plates, not only are there holes on the outer surface of the side plates of the cabinet, resulting in poor overall appearance, but some products also use plastic composite components, which require special cutting tools in processing and production, resulting in high production requirements and high product defect rates.

How to overcome the problems encountered by conventional cabinets will be one of the issues to be solved by the industry.

### SUMMARY

The present disclosure provides a tool-free cabinet device, capable of assembling a cabinet without needing to use tools, and being good in overall appearance.

The present disclosure proposes a tool-free cabinet device, comprising: a top plate and a bottom plate, respectively comprising an outer surface, an inner surface, and a plurality of configuration groove bodies, said configuration groove bodies respectively recessed in said inner surface, and said inner surface of said top plate facing said inner surface of said bottom plate; two side plates, respectively comprising a side plate outer surface and a side plate inner surface opposite to each other, a upper surface, a lower surface and an insertion groove, wherein said upper surface and said lower surface are respectively connected between said side plate inner surface and said side plate outer surface, each of said insertion grooves is recessed in said corresponding side plate inner surface, said upper surface faces said inner surface of said top plate, and said lower surface faces said inner surface of said bottom plate; a rear plate, wherein left and right sides of said rear plate are inserted in said correspond insertion grooves; and a plurality of assembly components, respectively comprising a female fastener and a male fastener, wherein each of said female fasteners is provided inside said corresponding configuration groove body, each of said female fastener comprises a first plate element, and a keyhole, said keyhole is passed through said corresponding first plate element, each of said male fasteners is respectively provided on said upper surface and said lower surface of each of said side plates, each of said male fastener is assembled inside said keyhole of said corresponding female fastener, so as to provide said side plates between said top plate and said bottom plate, respectively.

In an embodiment of the present disclosure, each of said male fasteners comprises a rivet part, a screw part, and a connection part, each of said connection parts is connected between said rivet part and said screw part corresponding thereto, and a diameter of each of said connection parts is smaller than a diameter of said corresponding rivet part, and a diameter of said rivet part is smaller than a diameter of said corresponding screw part.

In an embodiment of the present disclosure, each of said side plates comprises a plurality of screw lock holes, said screw lock holes are respectively provided on said corresponding upper surface and lower surface, said screw parts are fixed inside said corresponding screw lock holes, and said rivet part and said corresponding connection part are provided outside said corresponding screw lock hole.

In an embodiment of the present disclosure, each of said first plate elements comprises a first section and a second section, each of said second sections is connected to said first section corresponding thereto, each of said second sections is a slope structure, each of said second sections has a first side and a second side opposite to each other, each of said second sections is connected to said corresponding first section, a thickness of said first side of each of said second sections is smaller than a thickness of said corresponding second side.

In an embodiment of the present disclosure, each of said keyholes comprises a first hole edge area and a second hole edge area, each of said first hole edge areas is provided on said second section corresponding thereto, each of said second hole edge areas is provided on said first section corresponding thereto, each of said first hole edge areas is larger than said second hole edge area corresponding thereto, each of said connection parts is fixed to said second hole edge area corresponding thereto, and each of said rivet parts is positioned on said first plate element corresponding thereto.

In an embodiment of the present disclosure, each of said female fasteners comprises a second plate element and a positioning part, each of said first plate elements is connected to said second plate element corresponding thereto, each of said positioning parts is protrudingly provided on said second plate element corresponding thereto, and each of said positioning parts is adjacent to said first hole edge area corresponding thereto; when said male fastener is moved to said first hole edge area, each of said positioning parts is used to support said rivet part.

In an embodiment of the present disclosure, a diameter of each of said connection parts is smaller than a dimension of said first hole edge area and a dimension of said second hole edge area, respectively, and a dimension of said first hole edge area is larger than a diameter of said rivet part, a dimension of said second hole edge area is smaller than a diameter of said rivet part, said rivet part and said connection part connected thereto are passed through said first hole edge area in sequence, said male fastener is moved form said first hole edge area to said second hole edge area.

In an embodiment of the present disclosure, said top plate and said bottom plate respectively comprises an assembly groove, each of said assembly grooves is recessed in said inner surface corresponding thereto, and a position of each of said assembly grooves is different from positions of said configuration groove bodies, upper and lower sides of said rear plate are respectively inserted in said assembly groove of said top plate and said assembly groove of said bottom plate corresponding thereto.

Based on the above, the tool-free cabinet device of the present disclosure does not need to use tools when assembly, a cabinet can be assembled by assembling the male fastener in the female fastener.

In order to make the present disclosure more obvious and understandable, embodiments are given below, and detailed descriptions are given below with reference to the attached drawings.

### BRIEF DESCRIPTION OF THE DRA WINGS

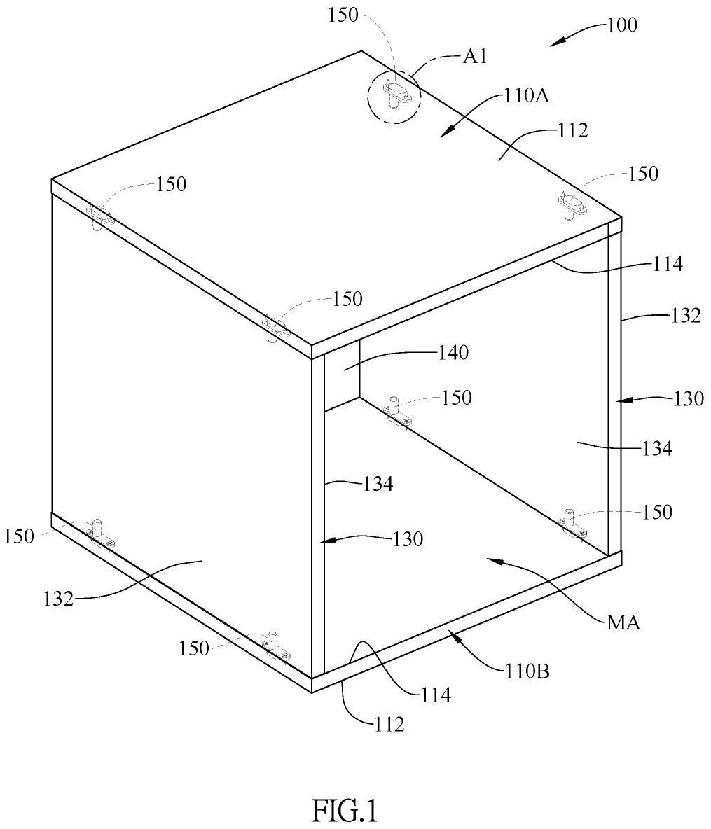

FIG. 1 is a perspective view of a tool-free cabinet device according to the present disclosure;

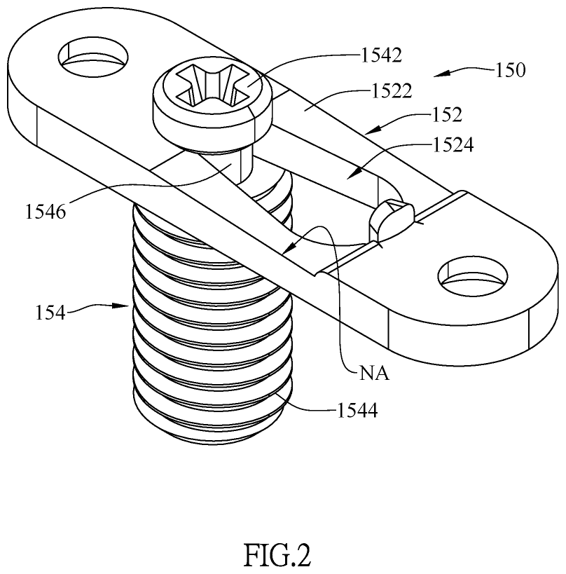

FIG. 2 is a perspective view of an assembly component in the area A1 of FIG. 1;

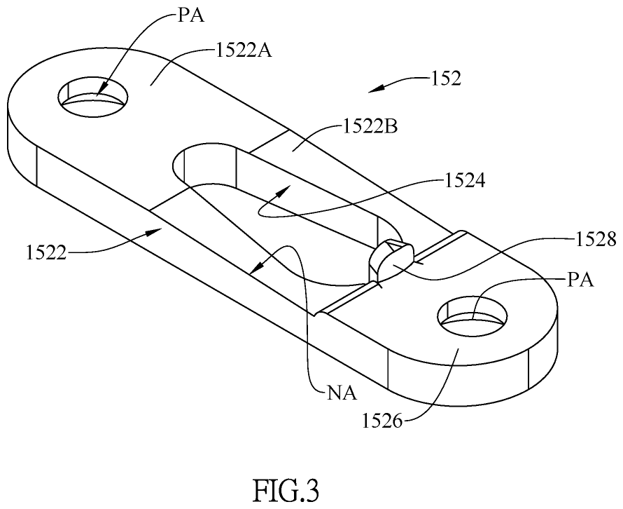

FIG. 3 is a perspective view of a female fastener according to the present disclosure;

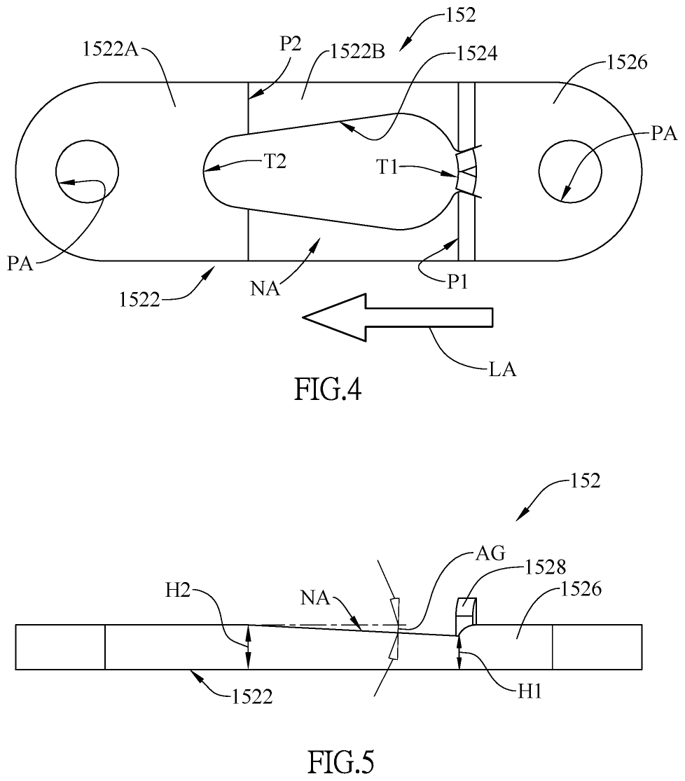

FIG. 4 is a top view of a female fastener according to the present disclosure;

FIG. 5 is a side view of a female fastener according to the present disclosure;

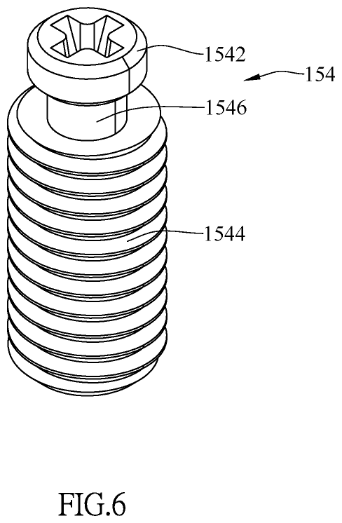

FIG. 6 is a perspective view of a male fastener according to the present disclosure;

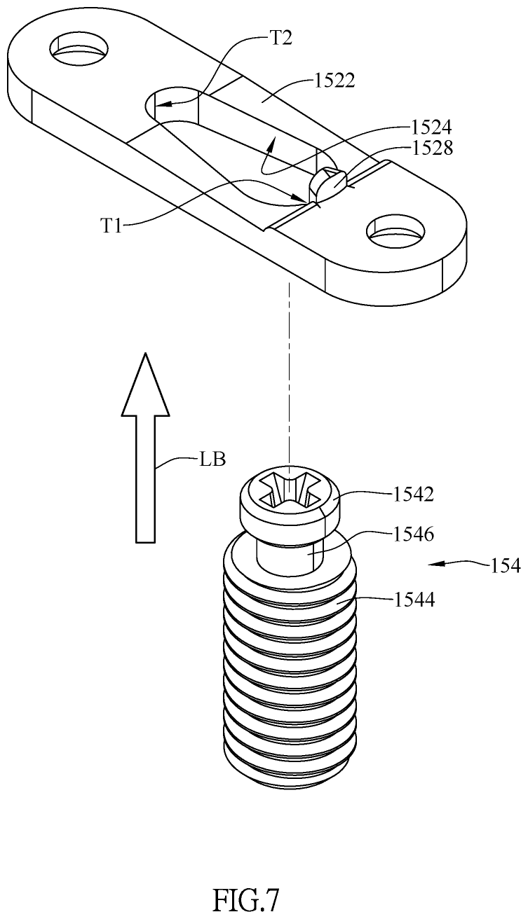

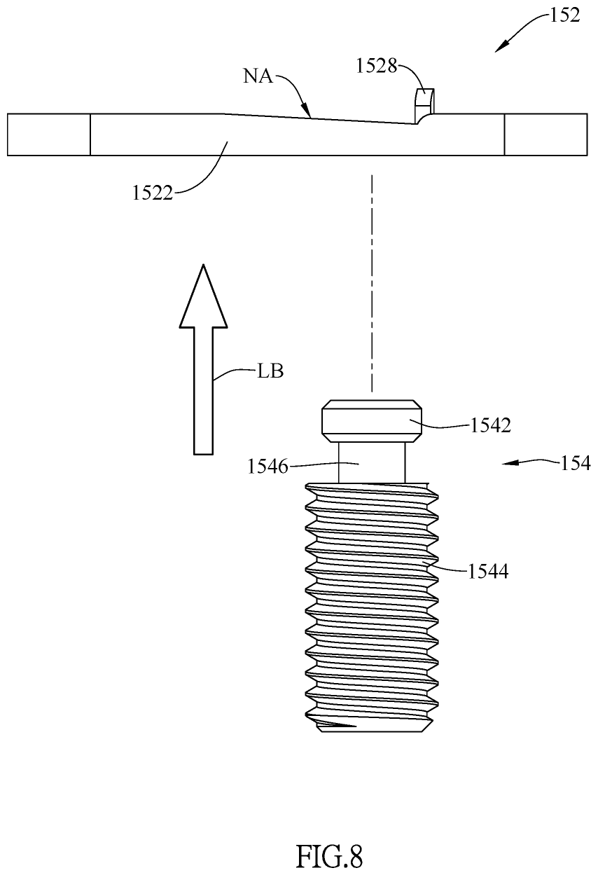

FIG. 7 is a perspective view of the assembly process of a male fastener and a female fastener according to the present disclosure;

FIG. 8 is a side view of the assembly process of a male fastener and a female fastener according to the present disclosure;

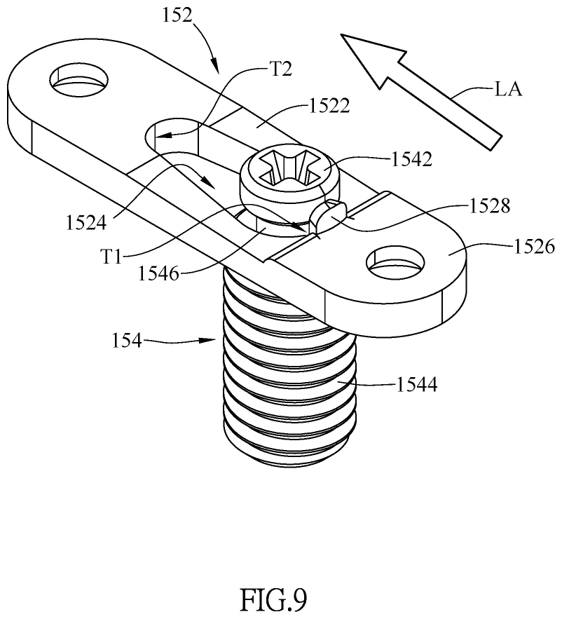

FIG. 9 is a perspective view of a first position that a male fastener is assembled in a keyhole in a female fastener according to the present disclosure;

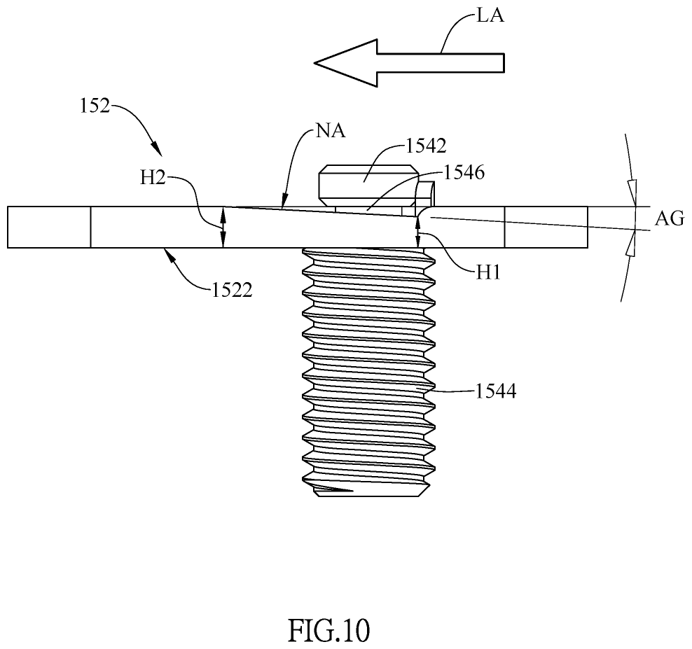

FIG. 10 is a side view of a first position that a male fastener is assembled in a keyhole in a female fastener according to the present disclosure;

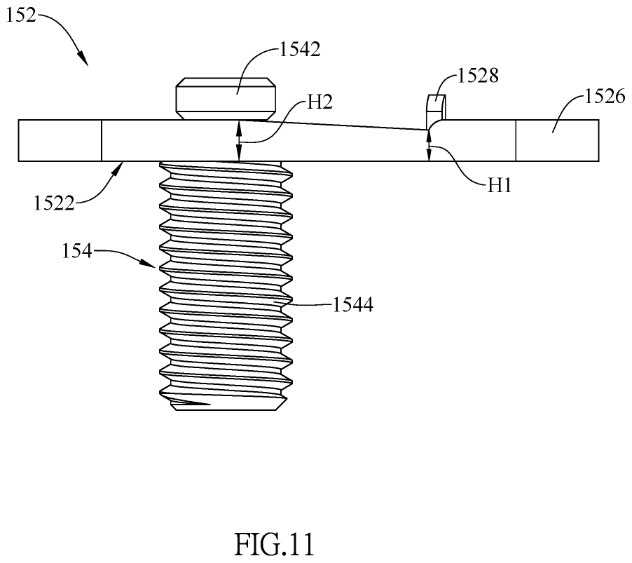

FIG. 11 is a perspective view of a second position that a male fastener is assembled in a keyhole in a female fastener according to the present disclosure;

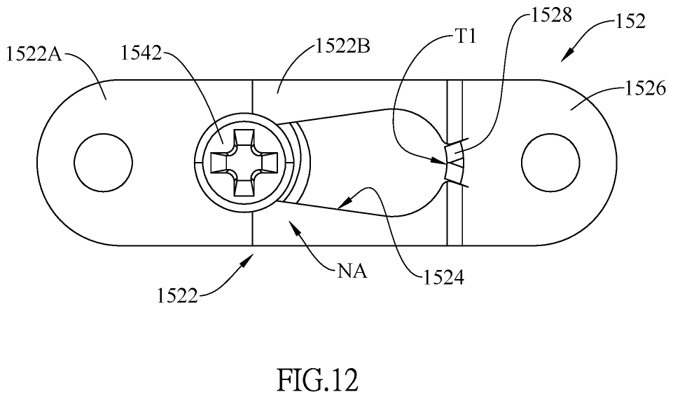

FIG. 12 is a top view of a male fastener assembled in a female fastener according to the present disclosure;

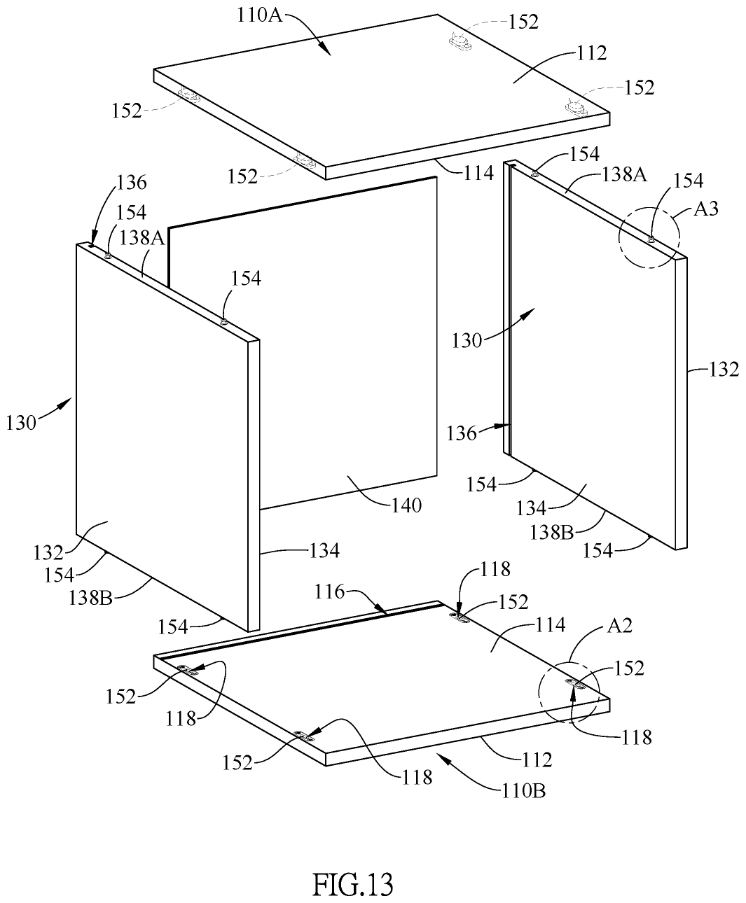

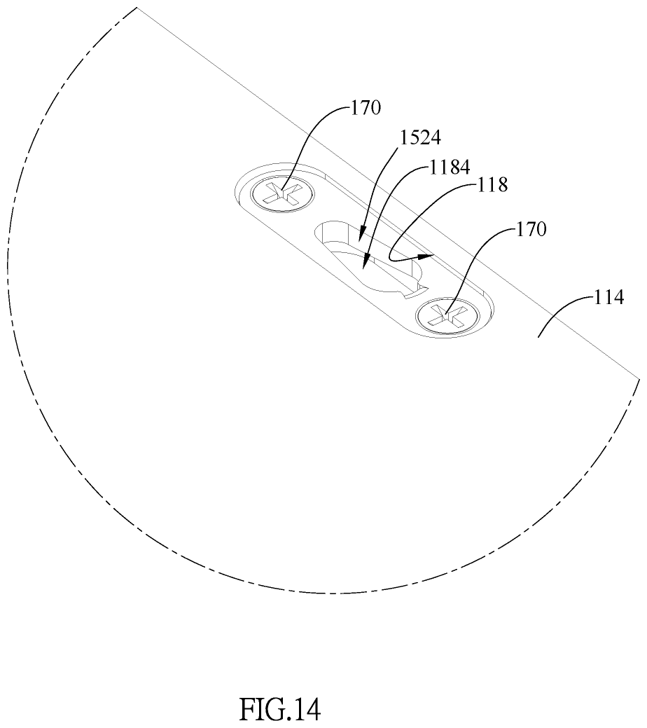

FIG. 13 is an exploded view of a tool-free cabinet device according to the present disclosure;

FIG. 14 is a partly enlarged view of a female fastener in the area A2 of FIG. 13 assembled on a bottom plate;

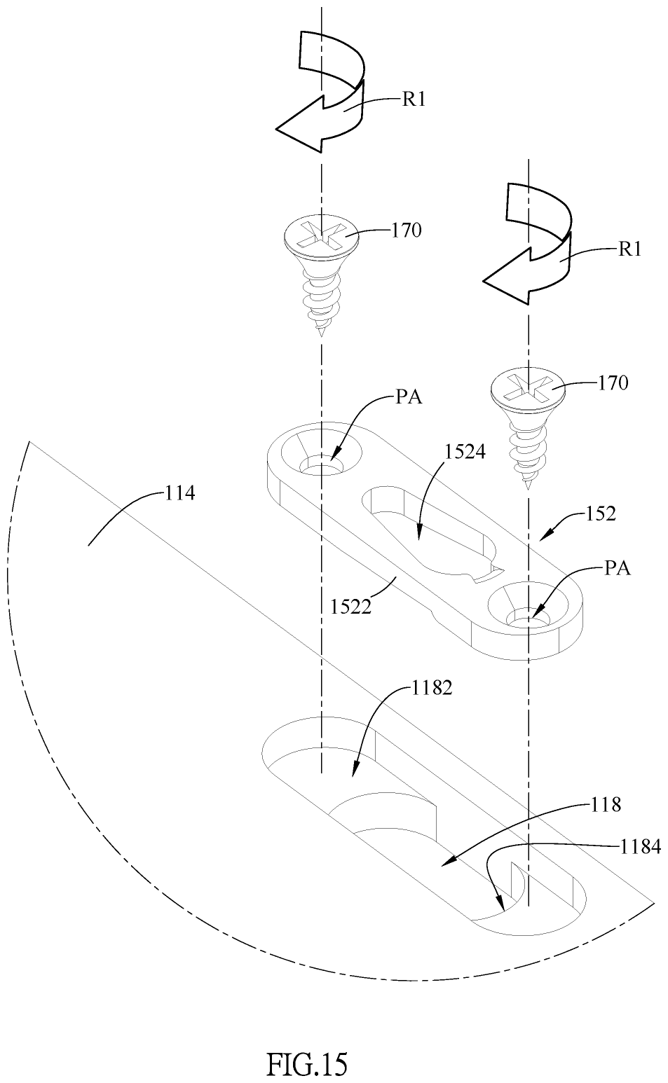

FIG. 15 is a partly enlarged view of the assembly process of the female fastener of FIG. 14;

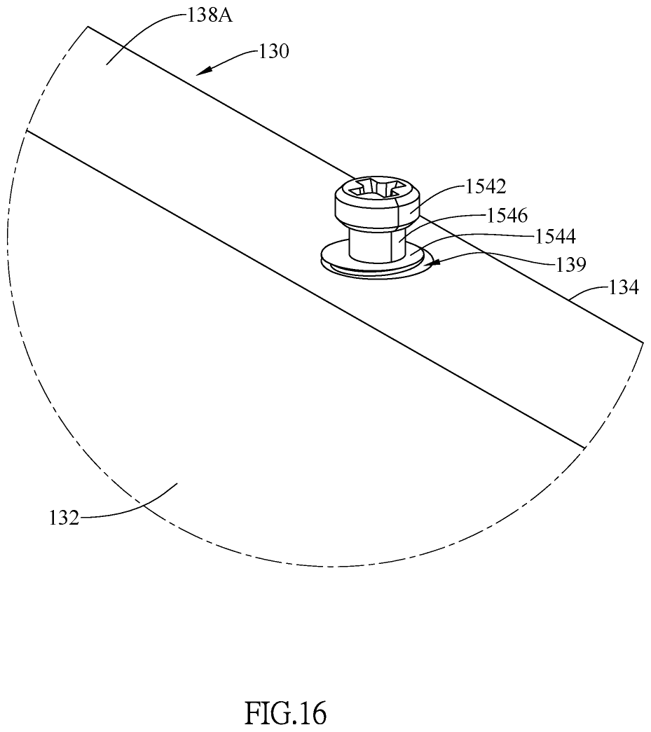

FIG. 16 is a partly enlarged view of a male fastener in the area A3 of FIG. 13 assembled on a side plate;

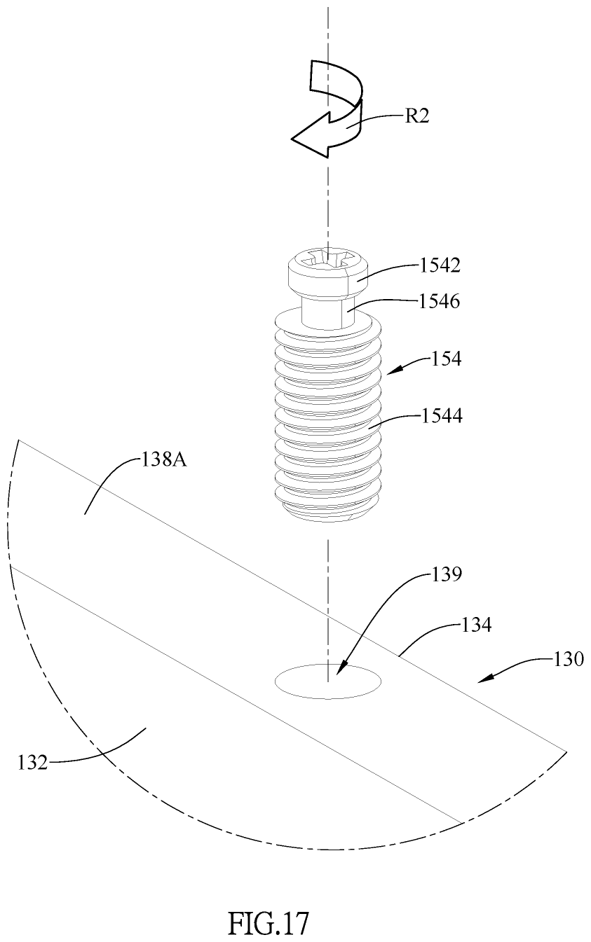

FIG. 17 is a partly enlarged exploded view of the assembly process of a male fastener of FIG. 16;

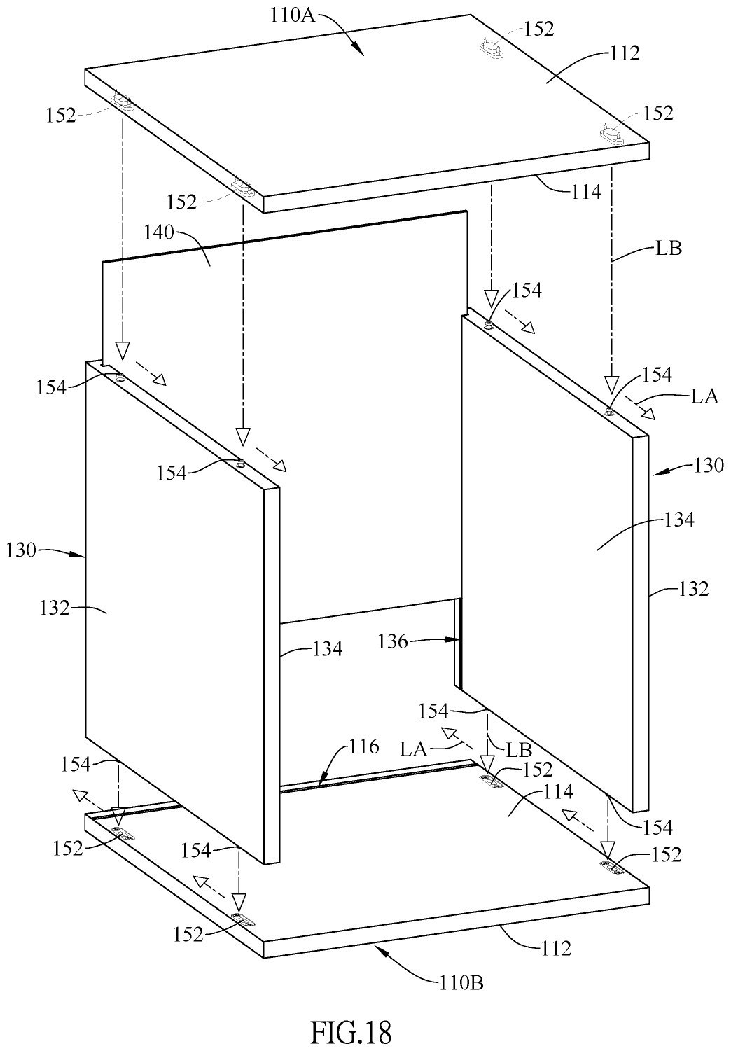

FIG. 18 is a schematic view of the assembly process of a tool-free cabinet device according to the present disclosure; and

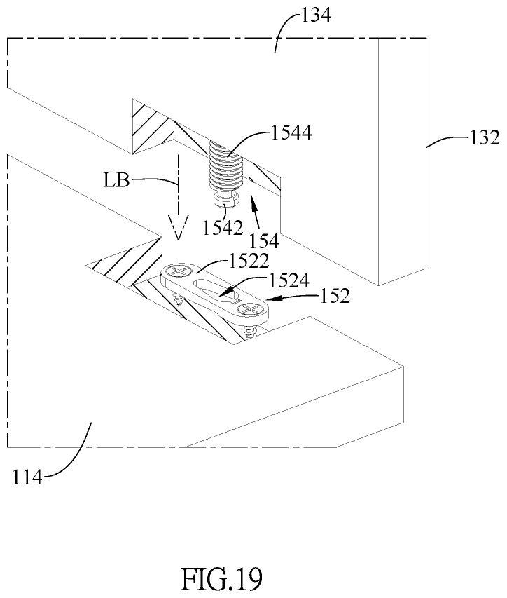

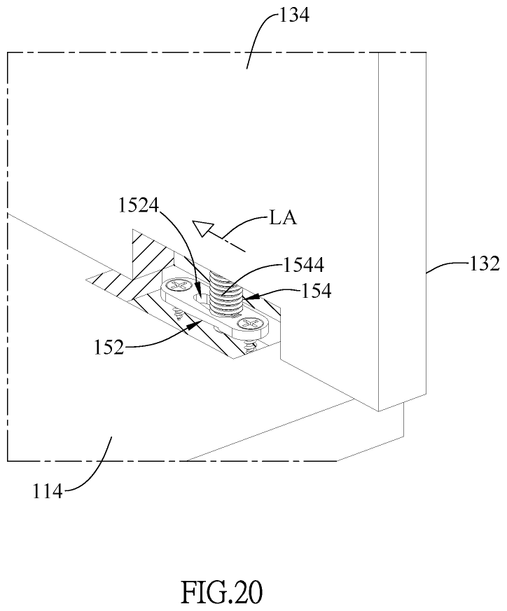

FIGS. 19 to 21 respectively are a schematic view of the assembly process of a male fastener assembled in a female fastener according to the present disclosure in sequence.

### DETAILED DESCRIPTION

The following embodiments are enumerated and described in detail with reference to the accompanying drawings, but the provided embodiments are not intended to limit the scope of the present disclosure. In addition, the drawings are for illustrative purposes only and are not drawn to original size. To facilitate understanding, the same elements will be identified with the same symbols in the following description.

The terms “including”, “comprising”, “having”, etc. mentioned in the present disclosure are all open terms, that is, they mean “comprising but not limited to”.

In the description of each embodiment, when terms such as “first”, “second”, “third”, “fourth”, etc. are used to describe elements, they are only used to distinguish these elements from each other, and there is no restriction on the order or importance of these elements.

In the description of various embodiments, the so-called “coupling” or “connection” may refer to two or more components making direct physical or electrical contact with each other, or indirectly making physical or electrical contact with each other. “Coupling” or “connection” can also refer to the mutual operation or action of two or more components.

FIG. 1 is a perspective view of a tool-free cabinet device according to the present disclosure. Referring to FIG. 1, a tool-free cabinet device 100 of the present disclosure includes a top plate 110A, a bottom plate 110B, two side plates 130, a rear plate 140, and a plurality of assembly components 150, where the top plate 110A is the same as the bottom plate 110B in structure. The top plate 110A and the bottom plate 110B are spaced a distance, and the two side plates 130 are provided between the top plate 110A and the bottom plate 110B; the upper and lower sides of each of these two side plates 130 are connected to the top plate 110A and the bottom plate 110B, and the two side plates 130 are spaced a distance. The top plate 110A, the bottom plate 110B, and these two side plates 130 are formed into a quadrilateral configuration. The upper and lower sides of the rear plate 140 are respectively connected to the top plate 110A and the bottom plate 110B, and the left and right sides of the rear plate 140 are connected to the corresponding side plates 130, so as to form a quadrilateral cabinet. The assembly components 150 are provided on the top plate 110A, the bottom plate 110B and the side plates 130, the top plate 110A and the side plates 130 as well as the bottom plate 110B and the side plates 130 are assembled together through the assembly components 150 to form a tool-free cabinet device 100.

FIG. 2 is a perspective view of an assembly component in an area A of FIG. 1. Referring to FIG. 2, the assembly component 150 of the present disclosure includes a female fastener 152 and a male fastener 154. In an embodiment, the assembly component 150 is stamped and formed into a hardware assembly from an iron plate divided into male fastener 154 and female fastener 152, where the female fastener 152 is a sheet of iron plate, the middle of which has a keyhole 1524 and a slope structure NA; a male fastener 154 is a rivet screw, and the male fastener 154 is engaged inside the keyhole 1524, allowing the male fastener 154 to be assembled inside the female fastener 152, and allowing the male fastener 154 to become increasingly tight during the sliding and blocking process through the slope structure NA.

The female fastener 152 is described through FIGS. 2 to 5 in the following, where FIG. 3 is perspective view of a female fastener according to the present disclosure. FIG. 4 is a top view of a female fastener according to the present disclosure. FIG. 5 is a side view of a female fastener according to the present disclosure. Referring to FIGS. 2 to 5, the female fastener 152 of the present disclosure includes a first plate element 1522, a keyhole 1524, a second plate element 1526, a positioning portion 1528, a slope structure NA, and two locking holes PA. The keyhole 1524 is penetrated in the first plate element 1522, and is a slot in the first plate element 1522, the keyhole 1524 includes a first hole edge area T1 and a second hole edge area T2 in sequence along an assembly direction LA, the two ends of the keyhole 1524 respectively are the first hole edge area T1 and the second hole edge area T2, and the hole of the first hole edge area T1 is larger than the hole of the second hole edge area T2. The first plate element 1522 is connected to the second plate element 1526, the positioning portion 1528 is protrudingly provided on the second plate element 1526, the positioning portion 1528 is a protruding structure projected out from the surface of the second plate element 1526, and the positioning portion 1528 is adjacent to the first hole edge area T1.

The first plate element 1522 includes a first section 1522A and a second section 1522B connected with each other, the second section 1522B is provided between the first section 1522A and the second plate element 1526, and the second section 1522B is adjacent to the positioning portion 1528. The first hole edge area T1 in the keyhole 1524 is provided on the second section 1522B. The second hole edge area T2 is provided on the first section 1522A. in addition, one locking hole PA is provided on the second plate element 1526.

The second area 1522B is a slope structure NA, and has a first side P1 and a second side P2 opposite to each other along the assembly direction LA, where the first side P1 is connected to the second plate element 1526, and the second side P2 is connected to the first section 1522A. the thickness H1 of the first side P1 of the first side P1 of the second section 1522B is smaller than the thickness H2 of the second side P2 of the second section 1522B, allowing the surface of the second section 1522B not to be flat to form the slope structure NA, and the thickness H1 dimension of the first side P1 of the second section 1522B gradually increases from the thickness H2 dimension of the second side P2 to form an inclined angle AG. That is to say, the thickness of the keyhole 1524 is not uniform, and the thickness of the first hole edge area T1 is smaller than the thickness of the second hole edge area T2.

Continuing to refer to FIGS. 2 and 6, FIG. 6 is a perspective view of a male fastener according to the present disclosure; the type of the male fastener 154 of the present disclosure is a rivet screw, including a rivet part 1542, a screw part 1544, and a connection part 1546, where the connection part 1546 is connected between the rivet part 1542 and the screw part 1544, and the diameter dimension of the connection part 1546 respectively smaller than the diameter dimension of the rivet part 1542 and the diameter dimension of the screw part 1544, and the diameter dimension of the screw part 1544 is larger than the diameter dimension of the rivet part 1542.

The following describes the assembly process of the assembly of the male fastener 154 in the female fastener 152, where FIG. 7 is a perspective view of the assembly process of a male fastener and a female fastener according to the present disclosure. FIG. 8 is a side view of the assembly process of a male fastener and a female fastener according to the present disclosure. FIG. 9 is a perspective view of the assembly of a male fastener in a first position of a keyhole in a female fastener according to the present disclosure. FIG. 10 is a side view of the assembly of a male fastener in a first position of a keyhole in a female fastener according to the present disclosure. FIG. 11 is a perspective view of the assembly of a male fastener in a second position of a keyhole in a female fastener according to the present disclosure. FIG. 12 is a top view of the assembly of a male fastener in a female fastener according to the present disclosure, where the first position is a position of the male fastener 154 located in the first hole edge area T1, and the second position is a position of the male fastener 154 located in the second hole edge area T2, allowing the male fastener 154 to be assembled in the female fastener 152. The diameter dimension of the connection part 1546 of the present disclosure is smaller than the dimension of the first hole edge area T1 and the dimension of the second hole edge area T2, and the dimension of the first hole edge area T1 is larger than the diameter dimension of the rivet part 1542, but the dimension of the second hole edge area T2 is smaller than the diameter dimension of the rivet part 1542, so as to allow the rivet part 1542 and the connection part 1546 connected thereto are respectively passed through the second hole edge area T2; the diameter dimension of the screw part 1544 is larger than the dimension of the first hole edge area T1 and the dimension of the second hole edge area T2, so that the screw part 1544 will not be passed through the keyhole 1524, and blocked by the first plate element 1522.

Under this arrangement, the male fastener 154 is moved along a buckling direction LB, allowing the rivet part 1542 and the connection part 1546 connected thereto to be passed through the hole of the first hole edge area T1 in sequence, but the screw part 1544 cannot be passed through the first hole edge area T1 and blocked, as shown in FIG. 9. Next, the male fastener 154 is moved along the assembly direction LA, allowing the male fastener 154 to be moved to the second hole edge area T2 from the first hole edge area T1, and since the hole dimension of the first hole edge area T1 is larger than the hole dimension of the second hole edge area T2, allowing the male fastener 154 to be gradually moved to the smaller hole of the second hole edge area T2, allowing the connection part 1546 to be gradually constrained by the hole area around the second hole edge area T2 in the keyhole 1524, and allowing the connection part 1546 to be fixed in the second hole edge area T2; the rivet part 1542 is positioned on the first plate element 1522, and due to the slop structure NA, the thickness of the first hole edge area T1 is smaller than the thickness of the second hole edge area T2, allowing the connection part 1546 to be also gradually constrained in a thickness direction. Furthermore, through the slope structure NA, the male fastener 154 can be increasingly tightened within the keyhole 1524 of the female fastener 152 during the sliding and blocking process.

In addition, as shown in FIG. 9, when the male fastener 154 is positioned in the first hole edge area T1, one side of the river part 1542 is supported by the positioning part 1528 instead of on the second plate 1526. This ensures that the rivet part 1542 is located above the hole of the keyhole 1524 and is more convenient for disassembly and assembly.

In addition, the depth of the male fastener 154 can be fine-tuned, such as adjusting the length of the connection part 1546, so that the processing tolerance can be eliminated when the male fastener 154 and the female fastener 152 are assembled.

The assembly process of the tool-free cabinet device is described in the following through FIGS. 13 to 21. Referring to FIG. 13 first, which is an exploded view of a tool-free cabinet device according to the present disclosure, the top plate 110A and the bottom plate 110B of the present disclosure respectively include an outer surface 112, an inner surface 114, an assembly groove 116 and four configuration groove bodies 118. The two opposite surfaces of the top plate 110A and the bottom plate 110B respectively are the outer surface 112 and the inner surface 114. As shown in FIG. 13, the inner surface 114 of the top plate 110A faces the inner surface of the bottom plate 110B. the assembly groove 116 and the four configuration groove bodies 118 are respectively recessed in the different positions of the inner surface 114. That is to say, the outer surface 112 of the top plate 110A and the outer surface 112 of the bottom plate 110B respectively are a flat surface, where the two configuration groove bodies 118 are positioned on one side of the inner surface 114, and another two configuration groove bodies 118 are positioned on another side of the inner surface 114; the distance between the two configuration groove bodies 118 on one side is the same as the distance between the two configuration groove bodies 118 on another side, and the assembly groove 116 is positioned outside the four configuration groove bodies 118. Of course, the distance between the configuration groove body 118 and the assembly groove 116 can be adjusted according to practical situations. It can be seen from this, the inner surface 114 of the top plate 110A and the inner surface 114 of the bottom plate 110B of the present disclosure are respectively used as an assembly surface, and the outer surface 112 of the top plate 110A and the outer surface 112 of the bottom plate 110B respectively are a flat surface, allowing the configuration groove bodies 118 and the assembly grooves 116 to be not visible from the appearance of the top plate 110A and the bottom plate 110B, thereby maintaining the overall appearance and smoothness.

FIG. 14 is a partly enlarged view of the assembly of a female fastener of the area A2 of FIG. 13 on a bottom plate. FIG. 15 is a partly enlarged exploded view of the assembly process of the female fastener of FIG. 14, where the structures of the top plate 110A and the bottom plate 110B are the same, and FIGS. 14 and 15 respectively tale the inner surface 114 of the bottom plate 110B as an example. Referring to FIGS. 14 to 15, the female fastener 152 of the present disclosure is provided inside the configuration groove body 118, and the height of the female fastener 152 does not exceed the configuration groove body 118, allowing the female fastener 152 to be hid inside the configuration groove body 118.

Specifically, the configuration groove body 118 includes a supporting part 1182 and an accommodating groove 1184, the supporting part 1182 is a block recessed in the inner surface 114, allowing the height of the supporting part 1182 to be lower than the height of the inner surface 114, and the accommodating groove 1184 is a recessed groove of the supporting part 1182. The female fastener 152 is provided inside the configuration groove body 118, passed through the locking hole PA through a locking element 170, and rotated around the rotating direction R1 to lock the female fastener 1152 inside the configuration groove body 118; the female fastener 152 is supported inside the supporting part 1182, and below the keyhole 1524 to directly face and be in communication with the accommodating groove 1184 of the configuration groove body 118, and thus allowing a movable space of the accommodating groove 1184 to be below the keyhole 1524.

Referring to FIG. 13 again, the two side plates 130 of the present disclosure are respectively provided between the top plate 110A and the bottom plate 110B, and each of the side plates 130 includes a side plate outer surface 132 and a side plate inner surface 134 opposite to each other, a insertion groove 136, a upper surface 138A, and a lower surface 138B, where the two opposite surfaces of the two side plates 130 respectively are the side plate outer surface 132 and the side plate inner surface 134, as shown in FIG. 13, the two side plate inner surfaces 134 face each other, and the upper surface 138A and the lower surface 138B are respectively connected between the side plate inner surface 134 and the side plate outer surface 132. Furthermore, the upper surface 138A faces the inner surface 114 of the top plate 110A, and the lower surface 138B faces the inner surface 114 of the bottom plate 110B. the insertion groove 136 is recessed in the corresponding side plate inner surface 134. That is, the side plate outer surface 132 of the side plate 130 is a flat surface.

FIG. 16 is a partly enlarged view of the male fastener in the area A3 of FIG. 13 assemble on a side plate. FIG. 17 is a partly enlarged exploded view of the assembly process of the male fastener of FIG. 16. Referring to FIGS. 13, 16 and 17, the type of the lower surface 138B is the same as the type of the upper surface 138A, and FIG. 16 and FIG. 17 respectively take the upper surface 138A as an example. The male fastener 154 of the present disclosure is respectively provided on the upper surface 138A and the lower surface 138B of the side plate 130, and the side plate 130 includes a screw lock hole 139 provided on the upper surface 138A. The screw lock hole 139 of the present disclosure is a through hole on the upper surface 138A of the side plate 130, and the number of the screw lock holes is adjusted according to the number of the male fasteners 154; similarly, the screw lock hole 139 is also provided on the lower surface 138B of the side plate 130 as the structure of the upper surface 138A. the screw part 1544 of the present disclosure is passed through the screw lock hole 139, and rotated around a rotating direction R2, so as to fix the screw part 1544 in the screw lock hole 139, and the rivet part 1542 and a part of the connection part 1546 connected thereto are provided outside the screw lock hole 139. It can be seen from this, the upper surface 138A of the side plate 130 and the side plate inner surface 134 of the present disclosure are respectively used as an assembly surface, and the side plate outer surface 132 of the side plate 130 is a flat surface, allowing the screw lock hole 139 and the insertion groove 136 to be not visible on the side plate 130, thereby maintaining the overall aesthetics and flatness.

FIG. 18 is a schematic view of the assembly process of a tool-free cabinet device according to the present disclosure. FIGS. 19 to 21 respectively are a schematic view of the assembly process of a male fastener being assembled in a female fastener according to the present disclosure in sequence. For ease of explanation, FIGS. 19 to 21 are partial cross-sections showing the assembly process of the male fastener 154 and the female fastener 152 respectively, and taking the side plate 130 being assembled on the bottom plate 110B as an example, the same principle applies when the top plate 110A is assembled on the side plate 130. Referring to FIGS. 13, 18 to 21, the rear plate 140 of the present disclosure is a flat plate, the two sides of the rear plate 140 are respectively inserted in the insertion grooves on the left and right side plates 130, allowing the rear plate 140 to be assembled between these two side plates 130. In addition, the insertion groove 130 is positioned adjacently to the assembly groove 116. For example, the two side plates 130 are respectively erected on both sides of the bottom plate 110B, or the two side plates 130 are respectively erected below both sides of the top plate 110A.

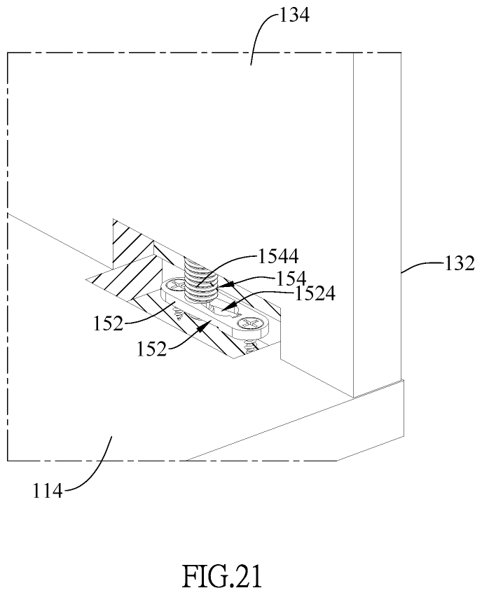

Next, the male fasteners 154 on the side plate 130 are respectively aligned with the female fasteners 152 on the bottom plate 110B. similarly, the female fasteners 152 on the top plate 110A are also respectively aligned with the male fasteners 154 on the side plate 130. Furthermore, the upper and lower sides of the rear plate 140 are respectively inserted in the assembly grooves 116 of the top plate 110A and the bottom plate 110B, allowing the rear plate 140 to be assembled between the top plate 110A and the bottom plate 110B. Along the buckling direction LB, the male fastener 154 is moved into the keyhole 152 in the female fastener 152, and as shown in FIG. 9, the rivet part 1542 and the connection part 1546 connected thereto can be passed through the hole of the first hole edge area T1 in sequence, but the screw part 1544 cannot be passed through the first hole edge area 11 and blocked. At the same time, the rivet part 1542 and the connection part 1546 can be in the accommodation groove 1184 as shown in FIG. 14 or FIG. 15. Next, the male fastener 154 is moved along the assembly direction LA as shown in FIG. 21, and the male fastener 154 is moved from the first hole edge area 11 (as shown in FIGS. 9 and 10) to the second hole edge area 12 (as shown in FIGS. 11 and 12), and the connection part 1546 is allowed to be gradually constrained by the hole area around the keyhole 1524. Furthermore, due to the slope structure NA, the male fastener 154 can become increasingly tight within the keyhole 1524 of the female fastener 152 during the sliding and blocking process, allowing the male fastener 154 to be assembled inside the keyhole 1524 of the female fastener 152. Similarly, the top plate 110A can also be assembled on the side plate 130 according to the above manner to form the tool-free cabinet device 100 shown in FIG. 1, and since all the outer surface 112, the side plate outer surface 132 and the rear plate 140 of the overall appearance of the tool-free cabinet device are flat, no hole can be seen from the appearance, so as to improve overall aesthetics and flatness.

To sum up, the tool-free cabinet device of the present disclosure does not need to use tools, and can be assembled by assembling the male fastener in the female fastener when assembly.

Furthermore, the present disclosure uses a slope structure to allow the male fastener to become increasingly tighter during the sliding and blocking process.

In addition, the female fastener disclosed in this disclosure is equipped with a positioning part, so that when disassembling the male fastener, one side of the rivet part is supported by the positioning part, which ensures that the rivet part is located above the hole of the keyhole and is more conducive to disassembly.

In addition, the male fastener of the present disclosure can finely adjust the depth, so that the machining tolerance can be eliminated when the male fastener and the female fastener are assembled.

Although the present disclosure has been disclosed as above in the form of embodiments, it is not intended to limit the disclosure. Anyone with ordinary knowledge in the technical field may make some modifications without departing from the spirit and scope of the disclosure. and modifications, so the scope of protection of this disclosure shall be subject to the claims attached.

What is claimed is:

1. A tool-free cabinet device, comprising:
a top plate and a bottom plate, respectively comprising an outer surface, an inner surface, and a plurality of configuration groove bodies, said configuration groove bodies respectively recessed in said inner surface, and said inner surface of said top plate facing said inner surface of said bottom plate;
two side plates, respectively comprising a side plate outer surface and a side plate inner surface opposite to each other, a upper surface, a lower surface and an insertion groove, wherein said upper surface and said lower surface are respectively connected between said side plate inner surface and said side plate outer surface, each of said insertion grooves is recessed in said corresponding side plate inner surface, said upper surface faces said inner surface of said top plate, and said lower surface faces said inner surface of said bottom plate;
a rear plate, wherein left and right sides of said rear plate are inserted in said correspond insertion grooves; and
a plurality of assembly components, respectively comprising a female fastener and a male fastener, wherein each of said female fasteners is provided inside said corresponding configuration groove body, each of said female fastener comprises a first plate element, and a keyhole, said keyhole is passed through said corresponding first plate element, each of said male fasteners is respectively provided on said upper surface and said lower surface of each of said side plates, each of said male fastener is assembled inside said keyhole of said corresponding female fastener, so as to provide said side plates between said top plate and said bottom plate, respectively.

2. The device according to claim 1, wherein each of said male fasteners comprises a rivet part, a screw part, and a connection part, each of said connection parts is connected between said rivet part and said screw part corresponding thereto, and a diameter of each of said connection parts is smaller than a diameter of said corresponding rivet part, and a diameter of said rivet part is smaller than a diameter of said corresponding screw part.

3. The device according to claim 2, wherein each of said side plates comprises a plurality of screw lock holes, said screw lock holes are respectively provided on said corresponding upper surface and lower surface, said screw parts are fixed inside said corresponding screw lock holes, and said rivet part and said corresponding connection part are provided outside said corresponding screw lock hole.

4. The device according to claim 2, wherein each of said first plate elements comprises a first section and a second section, each of said second sections is connected to said first section corresponding thereto, each of said second sections is a slope structure, each of said second sections has a first side and a second side opposite to each other, each of said second sections is connected to said corresponding first section, a thickness of said first side of each of said second sections is smaller than a thickness of said corresponding second side.

5. The device according to claim 4, wherein each of said keyholes comprises a first hole edge area and a second hole edge area, each of said first hole edge areas is provided on said second section corresponding thereto, each of said second hole edge areas is provided on said first section corresponding thereto, each of said first hole edge areas is larger than said second hole edge area corresponding thereto, each of said connection parts is fixed to said second hole edge area corresponding thereto, and each of said rivet parts is positioned on said first plate element corresponding thereto.

6. The device according to claim 5, wherein each of said female fasteners comprises a second plate element and a positioning part, each of said first plate elements is connected to said second plate element corresponding thereto, each of said positioning parts is protrudingly provided on said second plate element corresponding thereto, and each of said positioning parts is adjacent to said first hole edge area corresponding thereto; when said male fastener is moved to said first hole edge area, each of said positioning parts is used to support said rivet part.

7. The device according to claim 5, wherein a diameter of each of said connection parts is smaller than a dimension of said first hole edge area and a dimension of said second hole edge area, respectively, and a dimension of said first hole edge area is larger than a diameter of said rivet part, a dimension of said second hole edge area is smaller than a diameter of said rivet part, said rivet part and said connection part connected thereto are passed through said first hole edge area in sequence, said male fastener is moved form said first hole edge area to said second hole edge area.

8. The device according to claim 1, wherein said top plate and said bottom plate respectively comprises an assembly groove, each of said assembly grooves is recessed in said inner surface corresponding thereto, and a position of each of said assembly grooves is different from positions of said configuration groove bodies, upper and lower sides of said rear plate are respectively inserted in said assembly groove of said top plate and said assembly groove of said bottom plate corresponding thereto.
